(19) United States
(12) Patent Application Publication
(10) Pub. No.: US 2006/0008319 A1
(43) Pub. Date: Jan. 12, 2006

(54) Document inserting and removing device of file folder

(76) Inventor: Sin-young Lee, Gyeonggi-do (KR)

Correspondence Address: DILWORTH & BARRESE, LLP, 333 EARLE OVINGTON BLVD., UNIONDALE, NY, 11553, US

(21) Appl. No.: 11/178,827

(22) Filed: Jul. 11, 2005

(30) Foreign Application Priority Data
Jul. 12, 2004 (KR) 19788/2004

(51) Int. Cl. B42F 3/02

(52) U.S. Cl. 402/19

(57) ABSTRACT

The present invention discloses a document inserting and removing device of a file folder in which easy insertion and removal of documents is carried out into/from the file folder. The document inserting and removing device is provided wherein a collection of documents is provided in such a manner as to be bound by means of a double spring inserted into holes punched into the lower end of the collection of documents; a generally elongated support plate is formed in such a manner as to have plural pairs of locking members aligned at given intervals along the center portion thereof, each pair of locking members facing each other and having locking projections formed at the top ends thereof, the locking projections facing each other and being bent downwardly with respect to the locking members so as to form an acute angle to the locking members; and an outer cover is formed in such a manner as to have the support plate attached along the center portion thereof, whereby the collection of documents is inserted and removed into/from the support plate.

### BACKGROUND OF THE INVENTION

1. Field of the Invention

The present invention relates to a document inserting and removing device for a file folder that detachably retains tens through hundreds of documents therein, and more particularly, to a document inserting and removing device of a file folder in which easy insertion and removal of documents into/from the file folder can be achieved.

2. Background of the Related Art

A file folder that is used in this invention generally means notebooks, diaries, pocketbooks and so on, in which tens through hundreds of documents are bound and if necessary, the documents are exchanged with new ones.

The document file folder generally retaining a stack of documents therein is designed to replace the stack of documents with another stack of documents, if necessary.

As shown in FIG. 1, a conventional document file folder includes an outer cover 4, a collection of documents 2 retained inside the outer cover 4, a double spring 3 for coupling the collection of documents 2 with the outer cover 4, a support plate 10 attached in a length direction at the center of the outer cover 4, and a locking protrusion member 13 having a plurality of ring-type loops formed at predetermined intervals on the support plate 10.

The collection of documents (the documents bound by the double spring 3) is replaced, if necessary, and a process of inserting the collection of documents 2 into the center portion of the outer cover 4 will be described hereafter. First, the whole double spring 3 is positioned such that each spring is inserted between the ring-type loops, and then, a coupling bar 6 is inserted into the inner spaces of the ring-type loops, with a result that the double spring 3 is locked to the coupling bar 6 thus allowing the collection of documents 2 to be inserted into the file folder.

If the collection of documents 2 is to be removed from the file folder, the coupling bar 6 is drawn to lift the collection of documents 2 upwardly. As mentioned above, when the collection of documents 2 is inserted and removed, the coupling bar 6 should be employed. In some cases, however, it is a possibility that the coupling bar 6 will be lost or misplaced. At this time, the process of inserting and removing the collection of documents becomes also complicated.

To solve the above-mentioned problems, as shown in FIG. 2, the coupling bar 6 is not employed and the ring-type loops are formed of flexible plastic or synthetic resin. In this case, if a given external force is exerted to the ring-type loops, the overlapping portions thereof are opened and coupled one by one with the holes punched into the lower ends of the collection of documents 2. At this time, when the collection of documents 2 is forcibly pulled, it is removed from the file folder.

However, the above-described conventional configuration has some inconveniences in that upon the insertion of the collection of documents, the ring-type loops should be opened and connected one by one to the holes punched into the collection of documents, and during the use of the collection of documents, when an external force over a predetermined value is applied, the collection of documents may be easily removed from the file folder.

### SUMMARY OF THE INVENTION

Accordingly, the present invention has been made in view of the above-mentioned problems occurring in the prior art, and it is an object of the present invention to provide a document inserting and removing device of a file folder in which a collection of documents is easily inserted and removed into/from the file folder in a one-touch manner.

To accomplish the above object, according to the present invention, there is provided a document inserting and removing device of a file folder, wherein a collection of documents is provided in such a manner as to be bound by means of a double spring inserted into holes punched into the lower end of the collection of documents; a generally elongated support plate is formed in such a manner as to have plural pairs of locking members aligned at given intervals along the center portion thereof, each pair of locking members facing each other and having locking projections formed at the top ends thereof, the locking projections facing each other and being bent downwardly with respect to the locking members so as to form an acute angle to the locking members; and an outer cover is formed in such a manner as to have the support plate attached along the center portion thereof, whereby the collection of documents is inserted and removed into/from the support plate.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of showing a conventional document inserting and removing device of a file folder;

FIG. 2 shows the details of main parts of a conventional document inserting and removing device of a file folder;

FIGS. 3 and 4 are perspective views of showing a support plate employed in a document inserting and removing device of a file folder according to the present invention;

FIG. 5 shows the details of main parts of a document inserting and removing device of a file folder according to the present invention; and

FIG. 6 is a perspective view of showing the assembling state of a document inserting and removing device of this invention with a file folder.

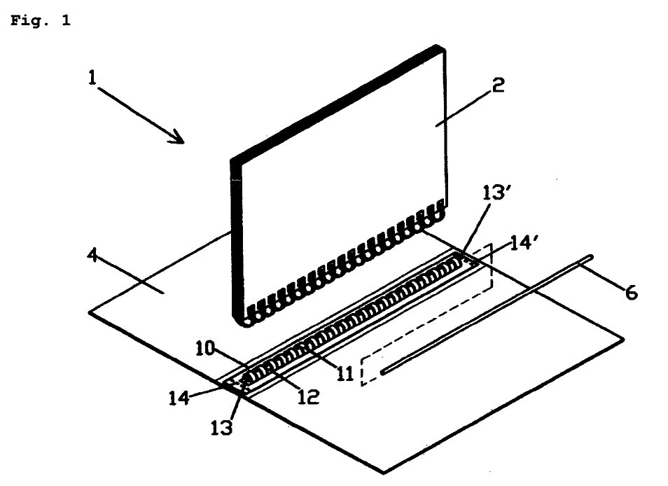

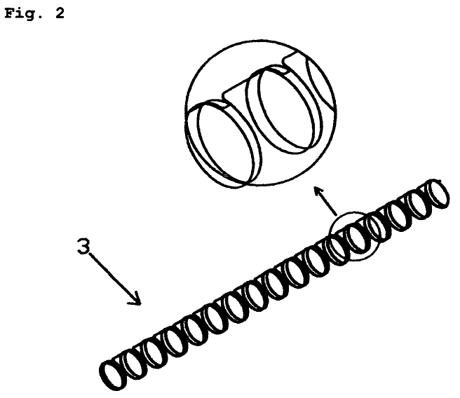

### DETAILED DESCRIPTION OF THE PREFERRED EMBODIMENT

Reference will now be made in detail to the preferred embodiments of the present invention, examples of which are illustrated in the accompanying drawings.

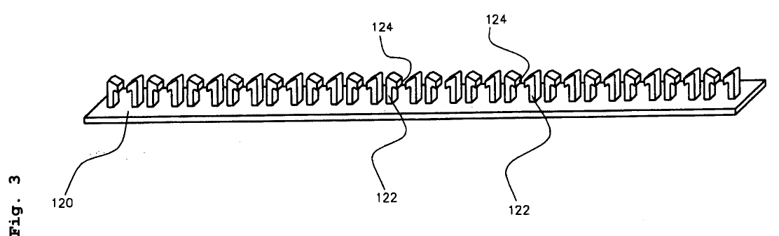

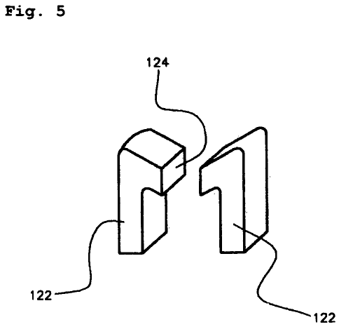

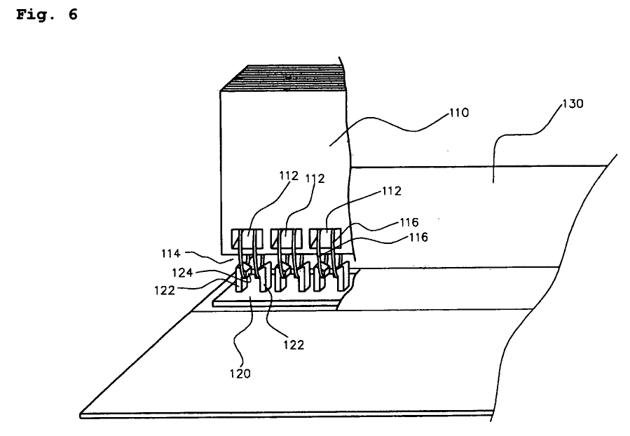

As shown in FIGS. 3 to 6, a document inserting and removing device of a file folder of this invention includes a collection of documents 110 bound by a double spring 114, a generally elongated support plate 120 to which the collection of documents 110 is secured, and an outer cover 130 to which the support plate 120 is attached.

The collection of documents 110 has a plurality of holes 112 formed at given intervals along the lower end thereof, and a double spring 114 that is formed by the alignment of plural pairs of loop type spring wires 116 at given intervals is inserted into the plurality of holes 112 and coupled therewith. In this case, the spring wires 116 in each hole 112 are separated at the same intervals as one another, and each pair of spring wires 116 are separated at the same intervals as the adjacent pair of spring wires 116.

The support plate 120 is a generally elongated plate that has the almost same length as the collection of documents 110, and plural pairs of locking members 122 are erected at given intervals along the center portion of the support plate 120, wherein each pair of locking members 122 are located to face each other. The distance between the locking members 122 constituting the pair of locking protrusions 122 is the same as the distance between the spring wires 116 constituting the pair of spring wires 116 in each hole 112, and the distance between the pair of locking members 122 and the adjacent pair of locking members 122 is the same as the distance between the pair of spring wires 124 and the adjacent pair of spring wires 124.

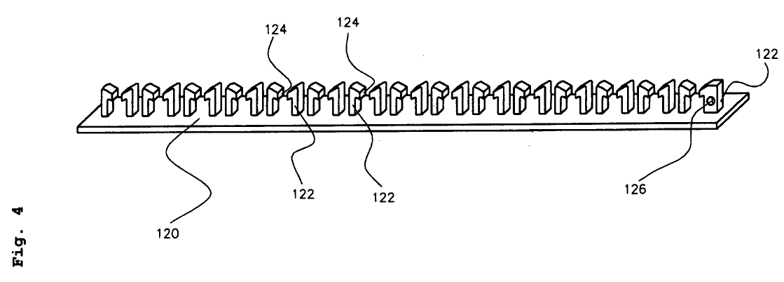

The pair of locking members 122 have locking projections 124 protrudingly formed from the top ends thereof in such a manner as to face each other. The locking projections 124 are bent downwardly with respect to the locking members 122 to have a generally staple shape. In this case, the angle of the locking projection 124 with respect to the locking member 122 is formed preferably between 60.degree. and 80.degree. The outermost locking member 122 as shown in FIG. 4 has a larger width than another locking members 122 and has an insertion hole 126 into which a loop is inserted for the convenient use of the device.

The top surface of each locking projection 124 is somewhat inclined such that the double spring 114 is easily slid and coupled with the locking members 122. The width of each locking projection 124 is greater than the thickness of each spring wire 116, but if it is too great, a substantially strong external force should be applied in the process of coupling the double spring 114. Therefore, the width of each locking projection 124 is, preferably, two to three times as large as the thickness of each spring wire 116.

The outer cover 130 to which the support plate 120 is attached along the center portion thereof retains the collection of documents 110 therein, and the outer cover 130 is formed of paper, plastic, or synthetic resin.

Now, an explanation on the operation of this device will be given.

If the collection of documents 110 is secured on the outer cover 130, the collection of documents 110 that is bound by the double spring 114 is first placed on the support plate 120.

When the collection of documents 110 is placed on the support plate 120, the plural pairs of spring wires 116 of the doubling spring 114 that are formed at the lower end of the collection of documents 110 are placed on the inclined top surfaces of the plural pairs of locking projections 124, and at this time, the collection of documents 110 is pushed downwardly, the spring wires 116 are slid along the inclined top surfaces of the locking projections 124. As a result, since the distance between the spring wires 116 becomes narrow the spring wires 116 are inserted into the space between the locking members 122.

After the insertion of the spring wires, the spring wires 116 are returned to their original shape under their recovering force such that they come in close contact with the inner surfaces of the locking members 122 and secured to the protruded portions of the locking projections 124. That is, if the collection of documents 110 is placed and pressed down on the support plate 120, the spring wires 116 are slid at a time between the locking members 122 for coupling with the locking members 122.

If the collection of documents 110 is to be removed from the support plate 120, each pair of spring wires 116 are held by a user's fingers and tightly contact with each other such that they are removed one by one from the locking members 122.

As mentioned above, the document inserting and removing device of a file folder according to the present invention conducts a document inserting process in an easy manner wherein when the collection of documents is placed and pushed down on the support plate, the spring wires are slid at a time and coupled to the locking members, and conducts a document removing process in an easy manner wherein when the spring wires are pressed to decrease the distance therebetween by a user's fingers, they are removed from the locking members.

While the present invention has been described with reference to the particular illustrative embodiments, it is not to be restricted by the embodiments but only by the appended claims, and therefore, it is to be understood that other modifications and variations may be made without departing from the substance and scope of the present invention, as those skilled in the art will readily understand. Such alternate modifications and variations are within the scope of the present invention which is intended to be limited only by the appended claims and equivalents thereof.

What is claimed is:

1. A document inserting and removing device of a file folder, wherein a collection of documents is provided in such a manner as to be bound by means of a double spring inserted into holes punched into the lower end of the collection of documents; a generally elongated support plate is formed in such a manner as to have plural pairs of locking members aligned at given intervals along the center portion thereof, each pair of locking members facing each other and having locking projections formed at the top ends thereof, the locking projections facing each other and being bent downwardly with respect to the locking members so as to form an acute angle to the locking members; and an outer cover is formed in such a manner as to have the support plate attached along the center portion thereof, whereby the collection of documents is inserted and removed into/from the support plate.

2. A document inserting and removing device of a file folder as claimed in claim 1, wherein the top surface of each locking projection is inclined downwardly.

3. A document inserting and removing device of a file folder as claimed in claim 1, wherein the acute angle between each locking member and each locking projection is formed between 60 degree and 80 degree.

4. A document inserting and removing device of a file folder as claimed in claim 1, wherein the outermost locking member formed on the support plate has an insertion hole passed through both sides thereof.
